(19) United States
(12) Patent Application Publication
(10) Pub. No.: US 2016/0347339 A1
(43) Pub. Date: Dec. 1, 2016

(54) Wagon Kit

(71) Applicant: George Horvath, Stoney Creek (CA)

(72) Inventor: George Horvath, Stoney Creek (CA)

(21) Appl. No.: 14/724,443

(22) Filed: May 28, 2015

(51) Int. Cl. B62B 3/02; B62B 3/10; B62B 5/00

(52) U.S. Cl. CPC B62B 3/02; B62B 5/0079; B62B 3/10

(57) ABSTRACT

A wagon kit includes a wagon that comprises a plurality of elements. Each of the elements is removable from each other such that the wagon may be selectively assembled and disassembled. The elements comprise a primary wheel section and a secondary wheel section. The secondary wheel section is removably coupled to the primary wheel section. A pair of sides is provided and each of the sides is removably coupled to the primary wheel section. A rear gate is removably attached to the primary wheel section and a front gate is removably attached to the primary wheel section. A seat is removably coupled between the pair of sides and a yoke is removably attached to the secondary wheel section.

### BACKGROUND OF THE DISCLOSURE

### Field of the Disclosure

The disclosure relates to wagon devices and more particularly pertains to a new wagon device that may be selectively assembled and disassembled.

### SUMMARY OF THE DISCLOSURE

An embodiment of the disclosure meets the needs presented above by generally comprising a wagon that comprises a plurality of elements. Each of the elements is removable from each other such that the wagon may be selectively assembled and disassembled. The elements comprise a primary wheel section and a secondary wheel section. The secondary wheel section is removably coupled to the primary wheel section. A pair of sides is provided and each of the sides is removably coupled to the primary wheel section. A rear gate is removably attached to the primary wheel section and a front gate is removably attached to the primary wheel section. A seat is removably coupled between the pair of sides and a yoke is removably attached to the secondary wheel section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a wagon kit according to an embodiment of the disclosure.

FIG. 2 is a right side view of an embodiment of the disclosure.

FIG. 3 is a top perspective view of an embodiment of the disclosure.

FIG. 4 is a bottom perspective view of an embodiment of the disclosure.

FIG. 5 is a kit view of an embodiment of the disclosure.

### DESCRIPTION OF THE PREFERRED EMBODIMENT

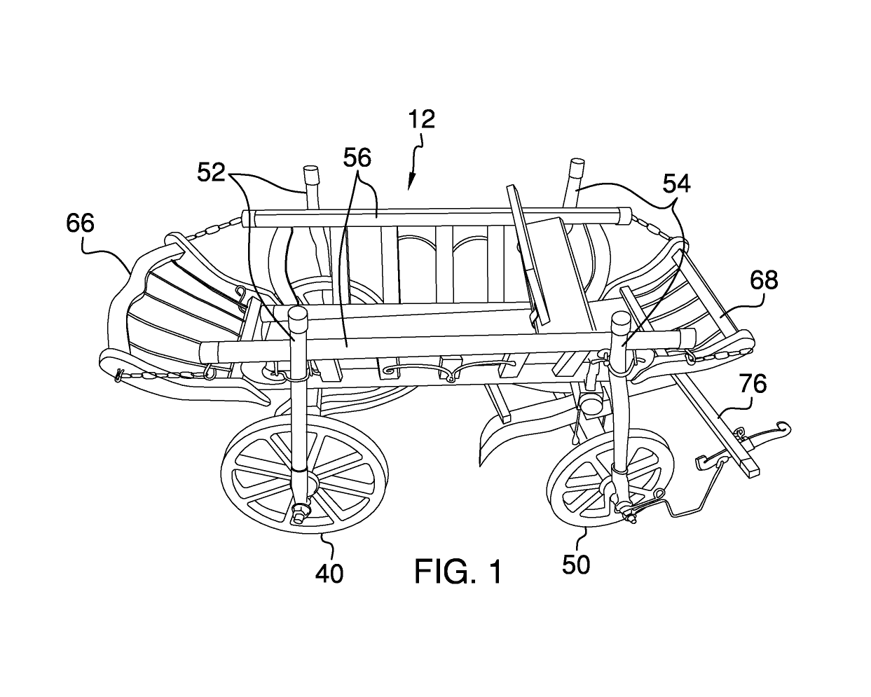

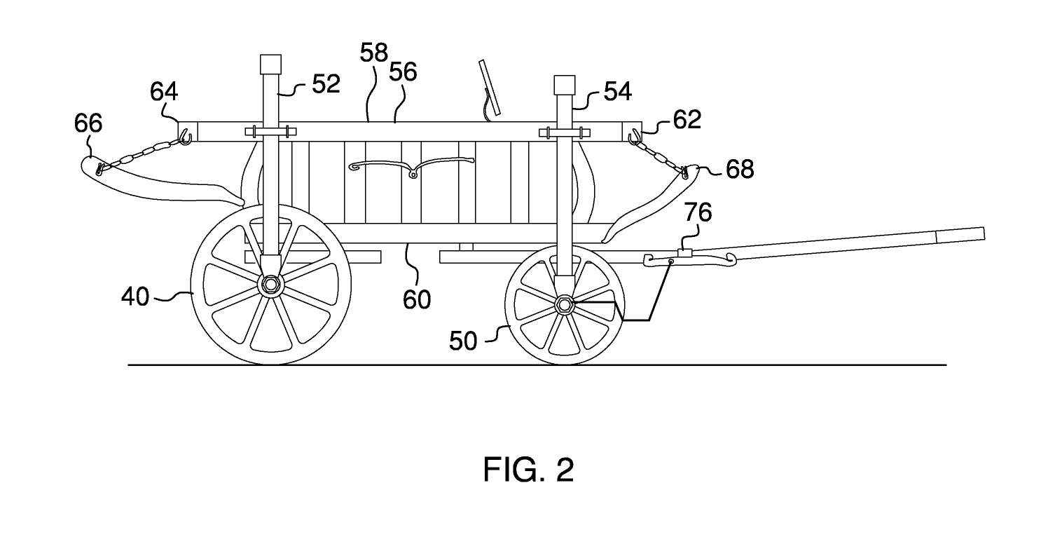

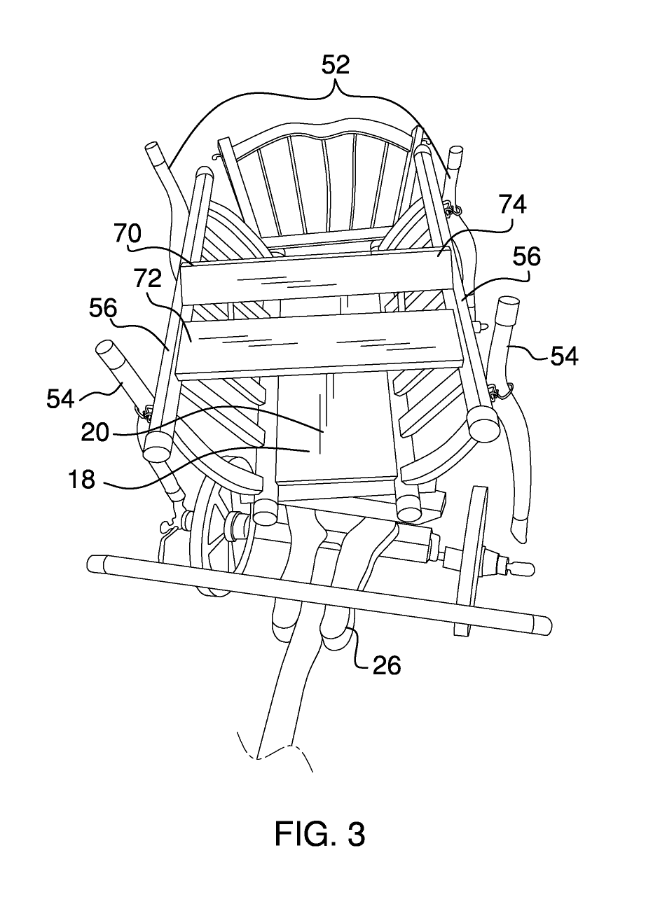

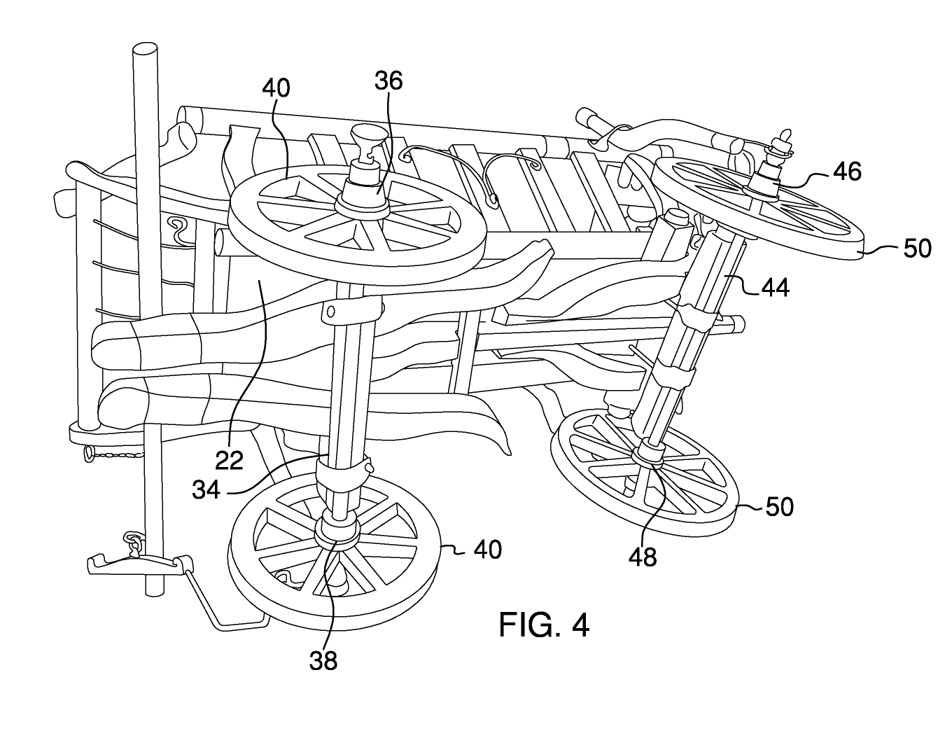

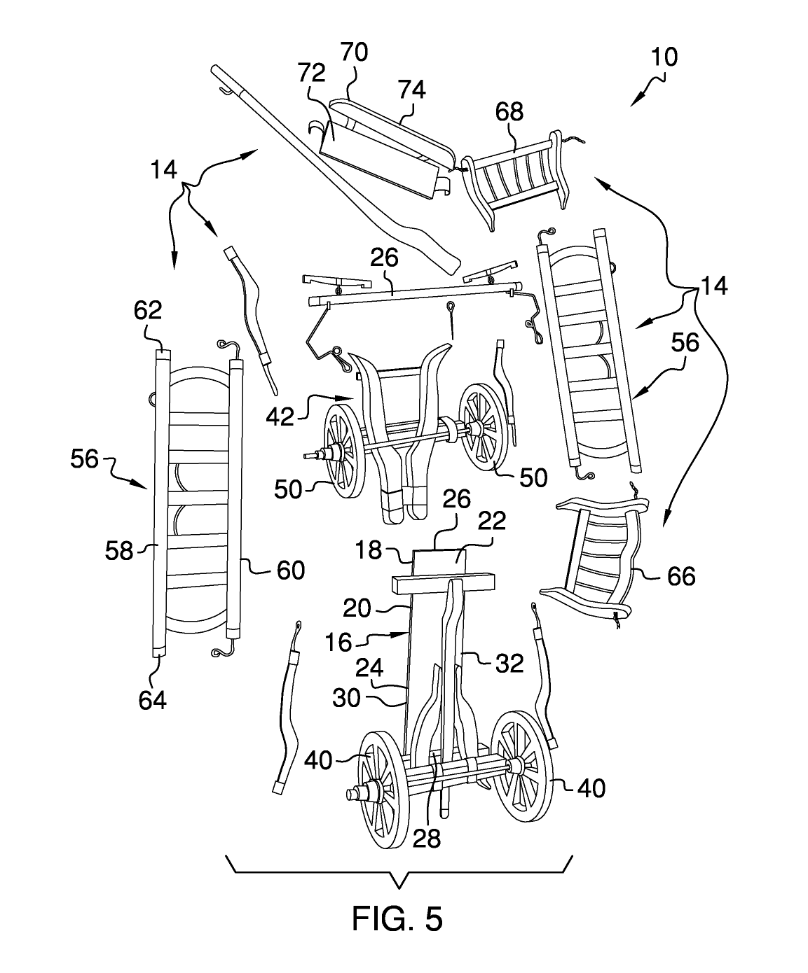

With reference now to the drawings, and in particular to FIGS. 1 through 5 thereof, a new wagon device embodying the principles and concepts of an embodiment of the disclosure and generally designated by the reference numeral 10 will be described.

As best illustrated in FIGS. 1 through 5, the wagon kit 10 generally comprises a wagon 12 that includes a plurality of elements 14. Each of the elements 14 is removable from each other such that the wagon 12 may be selectively assembled and disassembled. The wagon 12 may be assembled for display purposes or to facilitate the wagon 12 to be used as a toy.

The elements 14 comprise a primary wheel section 16 that includes a floor 18 that has a top side 20, a bottom side 22 and a peripheral edge 24 extending between the top side 20 and the bottom side 22. The peripheral edge 24 has a front edge 26, a back edge 28, a first lateral edge 30 and a second lateral edge 32. A first axle 34 is provided that has a first end 36 and a second end 38. The first axle 34 is attached to the bottom side 22 such that the first axle 34 extends laterally across the floor 18. The first axle 34 is positioned proximate the back edge 28. A pair of first wheels 40 is provided. One of the first wheels 40 is rotatably attached to the first end 36 and one of the first wheels 40 is rotatably attached to the second end 38.

A secondary wheel section 42 is provided and the secondary wheel section 42 is removably coupled to the primary wheel section 16. The secondary wheel section 42 engages the floor 18 such that the secondary wheel section 42 is positioned proximate the front edge 26 of the floor 18. The secondary wheel section 42 comprises a second axle 44 that has a first end 46 and a second end 48. A pair of second wheels 50 is provided. One of the second wheels 50 is rotatably coupled to the first end 46 of the second axle 44 and one of the second wheels 50 is rotatably coupled to the second end 48 of the second axle 44.

A pair of rear uprights 52 is provided and each of the rear uprights 52 is removably attached to an associated one of the first wheels 40. Thus, each of the rear uprights 52 extends upwardly from the associated first wheel 40. A pair of front uprights 54 is provided and each of the front uprights 54 is removably attached to an associated one of the second wheels 50. Thus, each of the front uprights 54 extends upwardly from the associated second wheel 50.

A pair of sides 56 is provided and each of the sides 56 has a top member 58 and a bottom member 60. The top member 58 of each of the sides 56 has a front end 62 and a back end 64. The bottom member 60 of each of the sides 56 is removably coupled to an associated one of the first lateral edge 30 and the second lateral edge 32 of the floor 18. The top member 58 of each of the sides 56 is attached to corresponding ones of the rear uprights 52 and the front uprights 54 when the sides 56 are coupled to the floor 18.

A rear gate 66 is removably attached to the floor 18. The rear gate 66 is positioned on the back edge 28 and the rear gate 66 is attached to the back end 64 of the top member 58 of each of the sides 56. A front gate 68 is removably attached to the floor 18. The front gate 68 is positioned on the front edge 26 and the front gate 68 is attached to the front end 62 of the top member 58 of each of the sides 56.

A seat 70 is provided that has a seat portion 72 and a back rest portion 74. The seat portion 72 is coupled between the top members 58 of each of the sides 56. The seat 70 is positioned proximate the front end 62 of the top member 58 of each of the sides 56. A yoke 76 is removably attached to the secondary wheel section 42.

In use, the wagon 12 is assembled for display purposes or for play purposes. The secondary wheel section 42 is attached to the primary wheel section 16. Each of the sides 56 is attached to the floor 18. Each of the pair of front uprights 54 and the pair of rear uprights 52 is attached to the floor 18. The front gate 68 and the rear gate 66 are each attached to the pair of sides 56. The seat 70 is attached between the pair of sides 56. The yoke 76 is attached to the secondary wheel section 42. The wagon 12 is disassembled in reverse order of the above stated steps of kit.

With respect to the above description then, it is to be realized that the optimum dimensional relationships for the parts of an embodiment enabled by the disclosure, to include variations in size, materials, shape, form, function and manner of operation, kit and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wagon kit configured to be assembled for display purposes, said kit comprising:
a wagon comprising a plurality of elements couplable together to form a wagon, each of said elements being removable from said wagon wherein said wagon is configured to be selectively assembled and disassembled, said plurality of elements comprising:
a primary wheel section, said primary wheel section includes a floor having a top side, a bottom side, and a peripheral edge extending between said to side and said bottom side, said peripheral edge having a front edge, a back edge, a first lateral edge and a second lateral edge, said primary wheel section further including a first axle having a first end and a second end, said first axle being attached to said bottom side such that said first axle extends laterally across said floor, said first axle being positioned proximate said back edge, said primary wheel section further includes a pair of first wheels, one of said first wheels being rotatably attached to said first end, one of said first wheels being rotatably attached to said second end, said first axle and said pair of first wheels being attached to said floor wherein said floor, said first axle, and said pair of first wheels define a single element of said wagon,
a secondary wheel section, said secondary wheel section being removably coupled to said primary wheel section;
a pair of sides, each of said sides being removably coupled to said primary wheel section;
a rear gate being removably attached to said primary wheel section;
a front gate being removably attached to said primary wheel section;
a seat being removably coupled between said pair of sides; and
a yoke being removably attached to said secondary wheel section.

2. (canceled)

3. (canceled)

4. (canceled)

5. The kit according to claim 1, wherein:
said primary wheel section includes a floor having a front edge; and
said secondary wheel section engaging said floor such that said secondary wheel section is positioned proximate said front edge of said floor.

6. The kit according to claim 1, wherein said secondary wheel section comprises:
a second axle having a first end and a second end; and
a pair of second wheels, one of said second wheels being rotatably coupled to said first end of said second axle, one of said second wheels being rotatably coupled to said second end of said second axle.

7. The kit according to claim 1, further comprising:
a pair of first wheels; and
a pair of rear uprights, each of said rear uprights being removably attached to an associated one of said first wheels such that each of said rear uprights extends upwardly from said associated first wheel.

8. The kit according to claim 1, further comprising:
a pair of second wheels; and
a pair of front uprights, each of said front uprights being removably attached to an associated one of said second wheels such that each of said front uprights extends upwardly from aid associated second wheel.

9. The kit according to claim 2, further comprising:
a pair of front uprights;
a pair of rear uprights; and
each of said sides has a top member and a bottom member, said top member of each of said sides having a front end and a back end, said bottom member of each of said sides being removably coupled to an associated one of said first lateral edge and said second lateral edge of said floor, said top member of each of said sides being attached to corresponding ones of said rear uprights and said front uprights when said sides are coupled to said floor.

10. The kit according to claim 9, wherein said rear gate is removably attached to said floor, said rear gate being positioned on said back edge, said rear gate being attached to said back end of said top member of each of said sides.

11. The kit according to claim 9, wherein said front gate is removably attached to said floor, said front gate being positioned on said front edge, said front gate being attached to said front end of said top member of each of said sides.

12. The kit according to claim 9, wherein said seat has a seat portion and a back rest portion, said seat portion being coupled between said top members of each of said sides, said seat being positioned proximate said front end of said top member of each of said sides.

13. A wagon kit configured to be assembled for display purposes, said kit comprising:
a wagon comprising a plurality of elements couplable together to from said wagon, each of said elements being removable from said wagon wherein said wagon is configured to be selectively assembled and disassembled, said plurality of elements comprising:
a primary wheel section, said primary wheel section including:
a floor having a top side, a bottom side, and a peripheral edge extending between said to side and said bottom side, said peripheral edge having a front edge, a back edge, a first lateral edge and a second lateral edge,
a first axle having a first end and a second end, said first axle being attached to said bottom side such that said first axle extends laterally across said floor, said first axle being positioned proximate said back edge, and
a pair of first wheels, one of said first wheels being rotatably attached to said first end, one of said first wheels being rotatably attached to said second end, said first axle and said pair of first wheels being attached to said floor wherein said floor, said first axle, and said pair of first wheels define a single element of said wagon;
a secondary wheel section, said secondary wheel section being removably coupled to said primary wheel section, said secondary wheel section engaging said floor such that said secondary wheel section is positioned proximate said front edge of said floor, said secondary wheel section comprising:
a second axle having a first end and a second end, and
a pair of second wheels, one of said second wheels being rotatably coupled to said first end of said second axle, one of said second wheels being rotatably coupled to said second end of said second axle;
a pair of rear uprights, each of said rear uprights being removably attached to an associated one of said first wheels such that each of said rear uprights extends upwardly from said associated first wheel;
a pair of front uprights, each of said front uprights being removably attached to an associated one of said second wheels such that each of said front uprights extends upwardly from aid associated second wheel;
a pair of sides, each of said sides having a top member and a bottom member, said top member of each of said sides having a front end and a back end, said bottom member of each of said sides being removably coupled to an associated one of said first lateral edge and said second lateral edge of said floor, said top member of each of said sides being attached to corresponding ones of said rear uprights and said front uprights when said sides are coupled to said floor;
a rear gate being removably attached to said floor, said rear gate being positioned on said back edge, said rear gate being attached to said back end of said top member of each of said sides;
a front gate being removably attached to said floor, said front gate being positioned on said front edge, said front gate being attached to said front end of said top member of each of said sides;
a seat having a seat portion and a back rest portion, said seat portion being coupled between said top member of each of said sides, said seat being positioned proximate said front end of said top member of each of said sides; and
a yoke being removably attached to said secondary wheel section.
